(19) United States
(12) Patent Application Publication
(10) Pub. No.: US 2018/0165711 A1
(43) Pub. Date: Jun. 14, 2018

(54) Smart Product Display Systems and Related Methods Providing Consumer Behavior Analytics

(71) Applicant: Frito-Lay North America, Inc., Plano, TX (US)

(72) Inventors: Jaime Montemayor, Plano, TX (US); David Patron, Frisco, TX (US); Dilip Rane, Coppell, TX (US)

(21) Appl. No.: 15/377,143

(22) Filed: Dec. 13, 2016

(51) Int. Cl. G06Q 30/02; G06Q 10/08; G06Q 30/06

(52) U.S. Cl. CPC G06Q 30/0255; G06Q 30/0269; H04W 88/06; G06Q 10/087; G06Q 30/0631; G06Q 30/0201

(57) ABSTRACT

The disclosed principles provide for various embodiments of a “smart” product display system capable of learning consumer shoppers' behaviors and preferences, as well as interacting with shoppers, retail personnel and product suppliers, in real-time. Exemplary goals for the disclosed product display systems and methods include understanding shopper behavior and trends by actively measuring inventory on the shelf in comparison with shoppers' demographic information, “sensing” the shoppers that stop by the rack and identify their demographics to show relevant advertisements to such shoppers; and validating the performance of internal techniques, or developing new techniques, for targeting shoppers as compared to actual shopper preferences determined by the smart product display system.

### TECHNICAL FIELD

The present disclosure relates to analytics regarding consumer shopping behavior, and more particularly to a unique smart product display system and related methods for providing consumer behavior analytics.

### BACKGROUND

Consumer shopper behaviors and preferences are constantly evolving. Also, as the demographics of such shoppers vary, so too do the preferences of each such demographic. Examples of this evolution include the types of retailers that such shoppers frequently visit, their expectations of product availability, and the types of occasions they intend to satisfy with their shopping for products (e.g., food and beverage occasions can be family gatherings, snacking, house parties, etc.). It is critical for companies to be aware of these ever-evolving shopper behaviors and preferences so that companies that sell the goods being consumed by these shoppers can continue to meet consumer needs. Missed opportunities to understand these consumer preferences could lead consumers to shift away from one company's products to those of a competitor, or to shift to new product categories altogether that better address such consumer needs, or even to a shift away from a certain retailer altogether.

Unfortunately, conventional methods capture only basic consumer shopping preferences and other related information. Also, conventional methods only address a smaller subset of shoppers, such as using shopper panels, “shop-alongs,” in-home ethnography, and shopper interviews at retail locations. Moreover, such conventional techniques can be expensive to scale up for a large pool of shoppers, and may only provide partial insights into the behaviors product manufacturers seek to understand.

Accordingly, there is a need in the art for an improved approach to gathering consumer shopper information and preferences that overcome the deficiencies of conventional methods. The disclose principles provide such an improved approach.

### SUMMARY

To overcome the deficiencies of the prior art, the disclosed principles provide for various embodiments of a “smart” product display system capable of learning consumer shoppers' behaviors and preferences, as well as interacting with shoppers, retail personnel and product suppliers, in real-time. Exemplary goals for the disclosed product display systems and methods include understanding shopper behavior and trends by actively measuring inventory on the shelf in comparison with shoppers' demographic information, “sensing” the shoppers that stop by the product display system (and any other satellite units placed throughout the merchant's location that this product display system controls or is otherwise interconnected with) and identifying their demographics to show relevant advertisements to such shoppers; and validating the performance of internal techniques, or developing new techniques, for targeting shoppers as compared to actual shopper preferences determined by the smart product display system.

To accomplish these exemplary goals, product display systems and related methods in accordance with the disclosed principles integrate various innovations and capabilities. Such innovations and capabilities may include pressure-sensitive racks to determine the presence of product inventory. Such product display systems may also include a data connection to transmit real-time data through a communications network back to a control center. The data connection may also be employed to transmit detailed recommendations to a merchandiser, which may include day-part inventory to stock, product consumption velocity, planogram setup, etc. Exemplary product display systems may also include local storage and streaming capabilities for multimedia content, such as targeted advertisements. Anonymous video sensors/analytics that can determine a shopper's demographic characteristics may also be included in the product display systems disclosed herein. Also, embedded display(s) for shopper-oriented multimedia and to display business-related information to front line associates may also be included. Product display systems disclosed herein may also include proximity/sound sensors to enable the display system to interact with shoppers and retail front line associates that are in close proximity.

The information generated by product display systems in accordance with the disclosed principles may then be collected and analyzed against different data sets to derive real-time and point-in-time insights of consumer shopper behavior and preferences. These additional data sets may include information regarding shipments of products to the store where the display system is placed, point of sale scans of that store, demographic information around the store, demand moment profile of the store location where the display system is located, and alternate consumer demographic information gathered from sources other than the consumers themselves. For example, consumer insights may be provided through consumer profiles identified by analyzing collected cell-phone information. In sum, a primary benefit of smart product display systems as disclosed herein is the insight that can be derived from real-time and granular information collected from the display systems that extends far beyond simply analyzing the amount of product that is placed on or sold from a retail store rack.

Numerous embodiments and advantages associated with each such embodiment are discussed in further detail below. In one exemplary embodiment, a product display system for providing consumer purchasing behavior analytics in accordance with the disclosed principles is described. In such an embodiment, the smart product display system includes a support structure having a power supply for powering one or more components of the smart product display system. In addition, such an embodiment may include one or more display units for presenting multimedia to consumers, one or more audio speakers for presenting multimedia content to consumers, and one or more cameras for capturing information regarding consumers proximate to the product display system. In addition, such embodiments may include one or more shelves (including remote units controlled by the smart product display system) for providing products for selection by consumers, where the one or more of the shelves have on-shelf sensors for detecting product data regarding the provided products. A data storage unit for storing the multimedia, captured information, and product data may also be included in such product display systems. Additionally, such systems may further include a processor for performing analytics regarding consumer shopping behavior with respect to products displayed on the product display system using one or more of the presented multimedia, the product data, and the captured information, wherein the performed analytics may then be stored in the data storage unit. Furthermore, the exemplary product display system may include a communications module for receiving and/or transmitting one or more of the presented multimedia, the product data, the captured information, and the performed analytics.

Accordingly, smart product display systems as disclosed herein allow both retailers and product manufacturers/suppliers to learn more about shoppers and their preferences in an efficient and real-time manner. Such analytics also allow uncovering insights hidden in shopper preferences and behavior not obtainable by conventional product display systems. Such benefits, as well as other advantages will be discussed through the exemplary embodiments presented herein.

### BRIEF DESCRIPTION OF THE DRAWINGS

The detailed description that follows, by way of non-limiting examples of embodiments, makes reference to the noted drawings in which reference numerals represent the same parts throughout the several views of the drawings, and in which:

FIG. 1A illustrates a front view of one embodiment of a product display system in accordance with the disclosed principles;

FIG. 1B illustrates a side view of the embodiment of a product display system illustrated in FIG. 1A;

FIG. 2 illustrates a top view of one embodiment of a shelf for use with a product display system in accordance with the disclosed principles and having a pressure sensor thereon;

FIG. 3 illustrates a top view of another embodiment of a shelf for use with a product display system in accordance with the disclosed principles and having multiple rear-mounted sensors thereon;

FIG. 4 illustrates a top view of yet another embodiment of a shelf for use with a product display system in accordance with the disclosed principles and having rear-facing on-shelf cameras;

FIG. 5A illustrates a front view of one embodiment of a shelf for use with a product display system in accordance with the disclosed principles and having multiple on-shelf mini displays;

FIG. 5B illustrates a close up view of the mini display unit on the shelf of FIG. 5A; and

FIG. 6 illustrates a top view of one embodiment of a shelf for use with a product display system in accordance with the disclosed principles and having audio speakers;

FIG. 7 illustrates an exemplary embodiment of a plurality of satellite display units that may be deployed in a store having the product display system, and communicate information to and from the product display system.

### DETAILED DESCRIPTION

In view of the foregoing, through one or more various aspects, embodiments and/or specific features or sub-components, the present disclosure is thus intended to bring out one or more of the advantages that will be evident from the description. The present disclosure makes reference to one or more specific embodiments by way of illustration and example. It is understood, therefore, that the terminology, examples, drawings and embodiments are illustrative and are not intended to limit the scope of the disclosure.

### Smart Product Display System

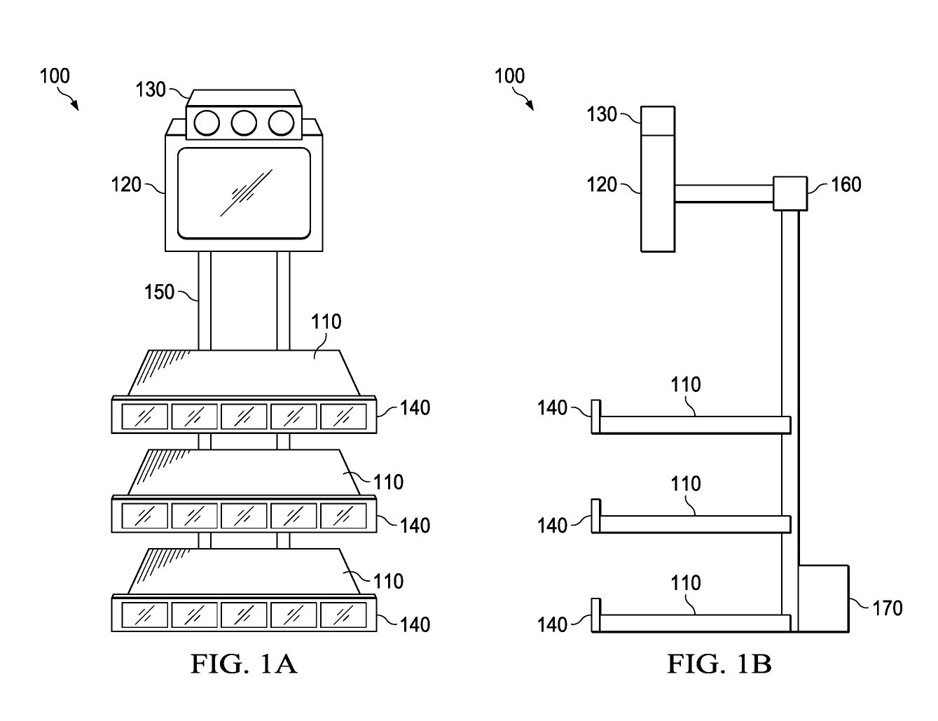

FIG. 1A illustrates a front view of one embodiment of a smart product display system 100 in accordance with the disclosed principles. FIG. 1B illustrates a side view of the smart product display system 100 illustrated in FIG. 1A. In advantageous embodiments, the product display system 100 may be used to store and display snack food merchandise for sale at a retailer, such as a grocery store. In some embodiments, the product display system 100 may be configured as a cooled display unit for use in displaying beverages or chilled foods for sale to consumers. Of course, the product display system 100 may be configured for the sale of consumer goods (including those categories of goods beyond food, snacks and beverages) as each such embodiment would include a combination of sensors for gathering data, multimedia components for display/presentation capabilities, telecommunications equipment for various forms of communication, and computational capabilities configured to handle communications, sensor data collection, multimedia storage and display, and other operations of the product display system 100, including administration and management of the stored multimedia, data collected and cleansed, transmission schedules of data, etc.

As shown in FIGS. 1A and 1B, the product display system 100 includes one or more display shelves 110 for holding products for sale. In addition, the product display system 100 includes a display unit 120, which in the illustrated embodiment is a monitor, such as an LCD, LED, OLED, ePaper, or any other type of visual display unit, as well as camera unit 130, which could be a 3D, infrared, thermal, or other type of camera technology, mounted above the display unit 120. Additionally, this embodiment of the product display system 100 includes on-shelf mini displays 140 for also displaying information to consumers or retail workers and associates, or product suppliers. Also included is a support structure 150 for joining each such component into a single product display unit.

Looking at the side view of FIG. 1B, the product display system 100 also includes as one of its sensors a near field communications (NFC) device, such as a communications device employing Bluetooth-low-energy transmission capabilities for transmitting and receiving information from a mobile communications devices such as consumer mobile telephones or even retail workers' or associates' mobile communication devices. Exemplary embodiments of such NFC sensors are discussed in detail below. Finally, the product display system 100 also includes a computing unit 170, which may be comprised of a fully functional self-contained computer capable of handling communications, sensor data collection, multimedia storage and display and other operations of the product display system 100.

### Sensors

Among the types of sensors that may be employed with a product display system in accordance with the disclosed principles to collect useful data are on-shelf pressure sensors, on-shelf cameras, on-shelf infrared sensors, sonar sensors, and 3D or other type of camera units, as mentioned above. Also as mentioned above, an NFC device 160, such as Bluetooth-capable devices, may also be employed. An example of such a device is an iBeacon unit. An iBeacon unit is a Bluetooth-low-energy (BTLE) emitting device that can be used to transmit a specific signature that mobile applications on consumers' mobile telephones can detect and initiate activities to engage mobile consumers in the proximity of the product display system 100. For example, when a consumer enters the range of detection of the iBeacon device mounted on the product display system 100, the consumer's mobile telephone having the appropriate application will detect the signal of the iBeacon, communicate with, for example, a marketing service through the iBeacon unit that will then determine the communications used to interact with the consumer, and the full experience will be rendered on the consumer's telephone. Of course, other types of NFC devices may also be employed to communicate and interact with consumers' mobile telephones.

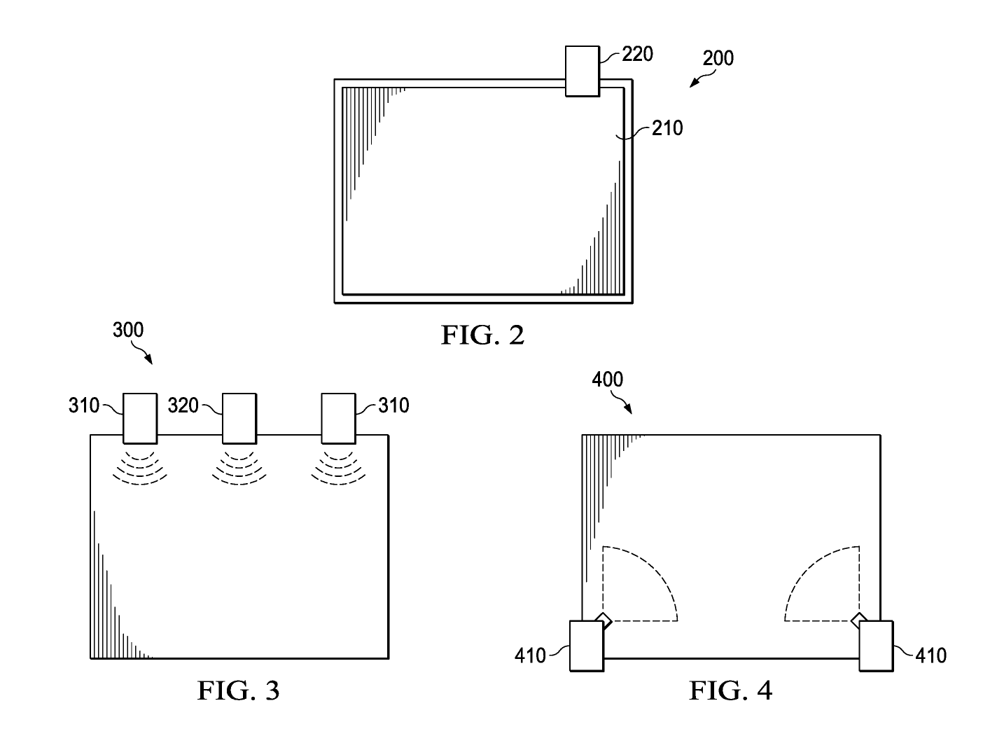

Another type of sensor that may be employed with a product display system according to the disclosed principles is an on-shelf pressure sensor. FIG. 2 illustrates a top view of one embodiment of a shelf 200 of a product display system configured in accordance with the disclosed principles and having an on-shelf pressure sensor 210. On-shelf pressure sensors can be installed on one or more of the shelves of a disclosed display system, and may be configured to detect the presence or absence of product on each such shelf. The type of product present or absent on each shelf may also be tracked using such sensors. For example, a specific product may be indexed for a specific shelf, with the on-shelf sensor calibrated to detect the amount of that product on the shelf Also, with a multi-zone on-shelf sensor, different zones of the same shelf may be calibrated to detect product indexed for each zone. The communication of such sensors, whether pressure sensors or other types, examples of which are discussed below, with the computing unit of the product display system may be through an on-shelf connector 220 which in turn is connected to the computing unit through wired or wireless connection.

Other sensors that may be employed by a product display system configured in accordance with the disclosed principles may include infrared sensors 310 and sonar sensors 320. FIG. 3 illustrates a top view of another embodiment of a shelf 300 for use with a product display system in accordance with the disclosed principles and having multiple rear-mounted sensors 310, 320 thereon. Such sensors 310, 320 can be used to measure distance, such as the distance between the sensor 310, 320 itself and product on the shelf 300. By measuring distances to product on the shelf 300, such sensors 310, 320 may also be employed to determine product stock on the shelf 300. Additionally, such distance measuring sensors 310, 320 may be used to detect the presence of consumers that are inspecting the product(s) on the shelf 300 as distinguished from consumers simply passing by the shelf 300. More specifically, consumers examining product(s) on the shelf 300 would typically be closer to the shelf 300 than those simply passing by, as well as be located in front of the shelf 300 for a longer period of time than those merely passing the shelf 300, and employing such sensors 310, 320 in this manner could distinguish between the two. Furthermore, such sensors, in particular infrared or sonar sensors (e.g., sensor 320), could also detect and count the number of people standing in front of the shelf 300, as well as for how long each one is present, which is further useful information for analytics performed by the disclosed smart product display system.

Still further sensors that may be employed on a shelf of a product display system in accordance with the disclosed principles are on-shelf cameras. FIG. 4 illustrates a top view of yet another embodiment of a shelf 400 for use with a product display system in accordance with the disclosed principles and having image recognition sensors, such as rear-facing on-shelf cameras 410. Such on-shelf cameras may be wide lens cameras, 3D cameras, infrared or thermal cameras, or any type of advantageous camera or camera system. In exemplary embodiments, such on-shelf cameras 410 can be installed along the corners of a shelf 400 or along support columns between shelves. These types of cameras 410 can not only detect the presence or absence of products on the shelf 400, but also can use image recognition to determine the brand/type of product on the shelf 400. In other embodiments, the on-shelf cameras 410 can be scanning sensors configured to read the Universal Product Code (UPC) or “bar code” on products, and in such embodiments, the camera(s) 410 may be positioned as needed to read the product codes either as the product sits on the shelf 400 or even as the product is removed from the shelf, i.e., passing in front of a strategically placed camera 410 as the product is removed by a consumer. In such embodiments, a product display system implemented as chest-style cooler lends itself well to such scans as products are lifted out of the cooler designed as disclosed herein. Of course, such on-shelf cameras 410 may also be implemented in other manners in order to gather data that is processed for the analytics provided by a smart product display system of the disclosed principles.

Another type of the sensor that may be implemented with a disclosed smart product display system is a 3D camera, such as the 3D camera 130 mounted at the top of the product display system 100 of FIG. 1A. Such high powered cameras can 130 can be implemented to detect several aspects of consumer shoppers in the vicinity of the product display system 100, such as a count of people examining and/or removing product on a shelf, as well as anonymized information such as the age cohort, gender, ethnicity, facial emotions and other demographic or related information of consumers engaging with the product display system 100. Indeed, such cameras 130 may even detect the manner of engagement with material displayed on the product display system 100 by such consumers when such information is desired for the analytics performed by the smart product display system disclosed herein. And as before, such 3D cameras, or other types of advanced cameras, may also be employed for other purposes and for gathering other types of information/data such cameras are known by those skilled in the art to capture, which may then be processed for the analytics provided by a smart product display system of the disclosed principles, and no limitation to the gathering of any particular information or data by such cameras, or any of the sensors disclosed herein, is intended or should be implied.

### Multimedia Components

Among the types of multimedia devices or components that may be employed with a product display system in accordance with the disclosed principles are a display device. Such a display device, such as the LCD display unit 120 mounted with the product display system 100 in FIG. 1A. Of course, types of display technology, either now existing or later developed, may also be employed. Such a display unit 120 may be used to display still or moving pictures to consumers, such as looping commercial videos or point of sale materials. By employing the display unit 120 with a smart product display system 100 of the present disclosure, the material displayed in the display unit 120 can be selected based on several factors including a pre-programmed schedule, time of day, specific day (e.g., holidays), and also on pre-programmed reaction to specific shoppers standing in front of the product display system 100. In the latter case, the displayed material may be, for example, specific commercials targeted to a certain age group or gender of shoppers, as detected by one or more sensors of as smart product display system as disclosed herein.

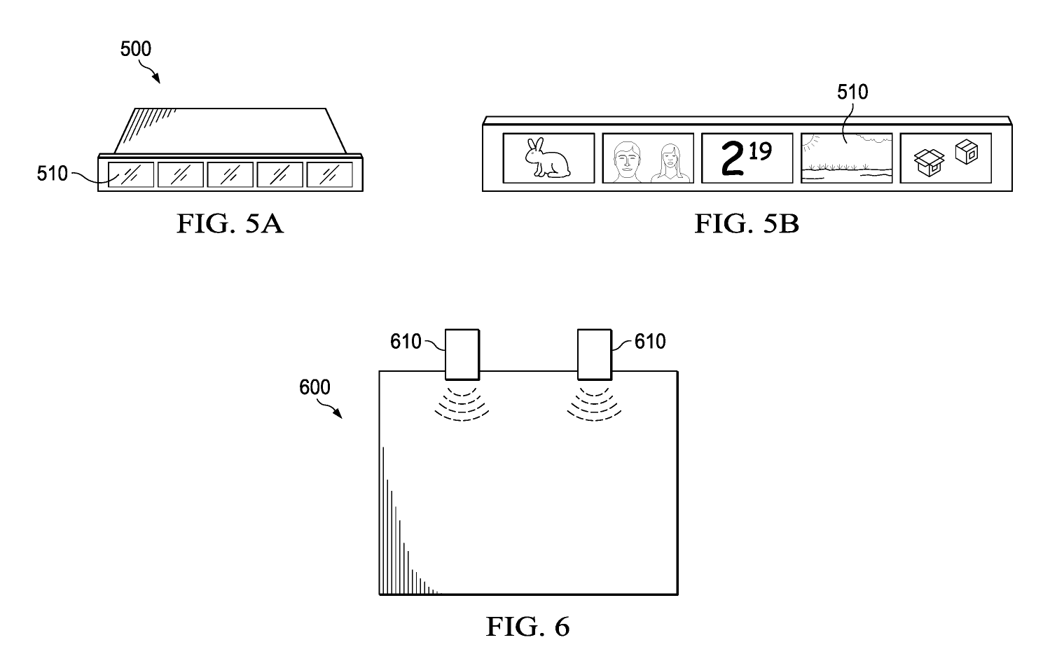

In additional to a primary display unit 120, a product display system 100 may also include on-shelf mini display units. FIG. 5A illustrates a front view of one embodiment of a shelf 500 for use with a product display system in accordance with the disclosed principles and having multiple on-shelf mini displays 510. FIG. 5B illustrates a close up view of the mini display unit 510 on the shelf 500 of FIG. 5A. In the illustrated embodiment, the mini display unit 510 is a display system that is located on the edge of the shelf 500 and can be comprised of one or more mini display screens that may display information such as product price, commercials and other promotional information, information regarding any discounts or sales of products, or other specific content sized to display on the edge of the shelf 500. The smart product display system can also engage shoppers with (digital-to-physical) events, such as displaying relevant information about products that consumers pick up from the product rack, displaying product ratings for such products and other products recommendations, for example, “don't forget the salsa with the chips you just picked up” or “Customers like you who selected these chips also selected this salsa.”

Still another type of multimedia component that may be included with a product display system according to the disclosed principles is audio speakers. FIG. 6 illustrates a top view of one embodiment of a shelf 600 for use with a product display system in accordance with the disclosed principles and having audio speakers 610. By employing speakers 610, audio information may be transmitted to consumers proximate to the product display system. Such information could be commercial or other promotional material, instructional information if the product on the product display system could benefit from it, recipes for use with products for sale on the display system, or even more general audio material like music. Moreover, the audio material provided from the speakers 610 may be coordinated with visual information being displayed by a display unit of the product display system.

Any incorporated speakers 610 can be configured to broadcast certain information to one or more detected consumers based on information collected about the consumer(s) by other sensors on the product display system. For example, the product display system could employ such sensors to determine demographic information regarding the consumer(s) and in response broadcast audio information specifically tailored for consumers in the detected demographic. Moreover, sensors on the product display system may be employed to determine from which shelf a consumer is touching or removing product. The product display system may then broadcast audio information specific to the product being selected via the speakers 610. In some embodiments, the audio speakers 610 may be directional audio speakers 610 capable of directing the broadcast audio in a desired direction. With such directional speakers 610, audio information may be directionally broadcast to a certain point proximate to the shelf 600. In such embodiments, the smart product display system as disclosed herein could detect the presence of one or more consumers next to the shelf 600 and direct audio towards them. Furthermore, directional audio speakers 610 can direct audio to specific areas near the shelf 600 so that consumers standing in specific locations can hear the information only at that location. In embodiments where sensors detect multiple consumers, multiple bits of audio information can be directed to each detected consumer, and may even be selected and thereafter directed based on detected consumer(s) demographics. As before, one or more audio speakers, whether directional or not, may also be employed for other purposes, including broadcasting information determined by the analytics provided by a smart product display system of the disclosed principles, and no limitation to any particular audio uses of such speakers is intended or should be implied.

### Computing Unit

To provide computing power for a product display system in accordance with the disclosed principles, a dedicated, on-board computational or computing unit may be employed such as the computing unit 170 illustrated on the product display system 100 of FIG. 1B. While a dedicated computing unit 170 is not necessarily required, where one is employed all of the data collected by the sensors is sent to and processed by the computing unit 170. In embodiments where a dedicated computing unit 170 is not employed, sensor data may be transmitted to another computing unit located at a different location. As such, multiple product display systems may transmit sensor data to a one or more distal computing units.

One possible advantage to employing a dedicated onboard computing unit 170 is that the product display system 100 could be configured so that it is entirely self-contained, and thus no external communications required. In such embodiments, the computing unit 170 could be loaded with all of the information for providing the consumers, as needed. Similarly, all of processing of received/captured data for consumer analytics could be done locally. However, even if the unit 170 is preloaded with all applicable information/materials for providing to consumers, it can be beneficial to still have the product display system 100 transmit externally, for example, to a centralized data center, so that processed consumer analytics can still be sent to such data centers for other uses.

A computing unit, whether located with the product display system or distal therefrom for use with one or more product display system, is employed in one respect to collect sensor data, such as exemplary sensor data discussed above. The exemplary computational unit 170 of FIG. 1B is housed in a secure container and attached to product display system 100. The unit 170 may also be simply located near the product display system 100 rather than mounted on it. A computing unit as disclosed herein may be configured to contain the logic to capture sensor data from the sensors dispersed on the product display system. Also, a computing unit may be used to store information/material to be displayed, broadcast, transmitted or otherwise provided to consumers or retail personnel, as well as similar data or information captured during use of the product display system. Furthermore, such a computing unit may also be configured to communicate with distil data collection center to both transmit and receive data for use in the product display system, as well as to manage the content and operation of the product display system when located in a retail establishment.

Examples of data collection captured by the local sensors include the computing unit 170 being configured to sample the presence/absence of product on shelves of product display system, as well as receive 3D camera telemetry of shoppers/consumers located proximate to the product display system. As also mentioned above, the storage capabilities of the computing unit includes not only the captured data, but also the storage and organization of multimedia materials that may be provided to consumers or even retail personnel, as needed. Thus, the computing unit includes the capability to determine what multimedia material is to be displayed on the display unit and on-shelf mini displays, and the audio material for broadcast by the onboard sound system.

### Communication Elements

To provide communications to and from a smart product display system configured in accordance with the disclosed principles, several communications elements may be provided. Such a product display system can include communication capabilities for short range (e.g., around the immediate area/proximity of the product display system), medium range (e.g., within the retail location), and wide-area (e.g., data or cellular network communications). Such communications elements may be provided within or elsewhere on the product display system 100 and be in wired or wireless communication with the computing unit 170.

Short range communications provide the product display system with the capability to interact with consumers (e.g., by simulating an iBeacon), or two-way communication with an application stored on a retail personnel associated with the retail establishment or even personnel associated with the supplier of products being displayed. For example, such personnel may employ hand held devices that may communicate with the short range unit of the product display system. Such short range communications capability may include Bluetooth two-way communications and Bluetooth Low Energy protocol as exemplary communications protocols, but of course other short range or near field communications protocols may also be employed.

The medium range communication capability enables a product display system according to the disclosed principles communicate with local area wireless networks, such as the retail location's WiFi network, for communications from the product display system to systems within the location. Such communications could be to keep track of product inventories with the retail location's system, could be used to transmit data external to the retail location via the location's communications network, or could even be used for communications between multiple product display systems or remote shelves located throughout the same location using, for example, a ZigBee® communications protocol. Medium range communications may also be on a proprietary communications network of a retail product manufacturer, such as the PepsiCo® Smart Equipment Network (via WiFi 802.11 protocol). Of course, other uses for such medium range communications by and with a product display system as disclosed herein may also be employed.

Wide area communication capabilities may also be included in a product display system as disclosed herein. For example, in the absence of a WiFi or other local area connection through which external communication can be achieved, a product display system of the disclosed principles may communicate externally of the retail location via 3G/4G/LTE networks by using a cellular network communications unit or adapter. Such wide area communications capabilities allows a product display system to communicate directly with external data facilities, such the distributor or manufacturer's systems of the products displayed on the product display system. This options allows the product display system to fully function without the need to employ a retail location's communications network, or in locations that do not have a network at all. In some embodiment, to limit the potential expenses of such wide area communications, the product display system may be configured to only certain aggregated data in batches, as opposed to real time data transmissions. Alternatively, the wide area communications may be employed for only the transmission of certain aggregated data, while other data may be provided via short range communications when a representative of the supplier or manufacturer of the displayed products are at the product display system.

### Satellite Display Units

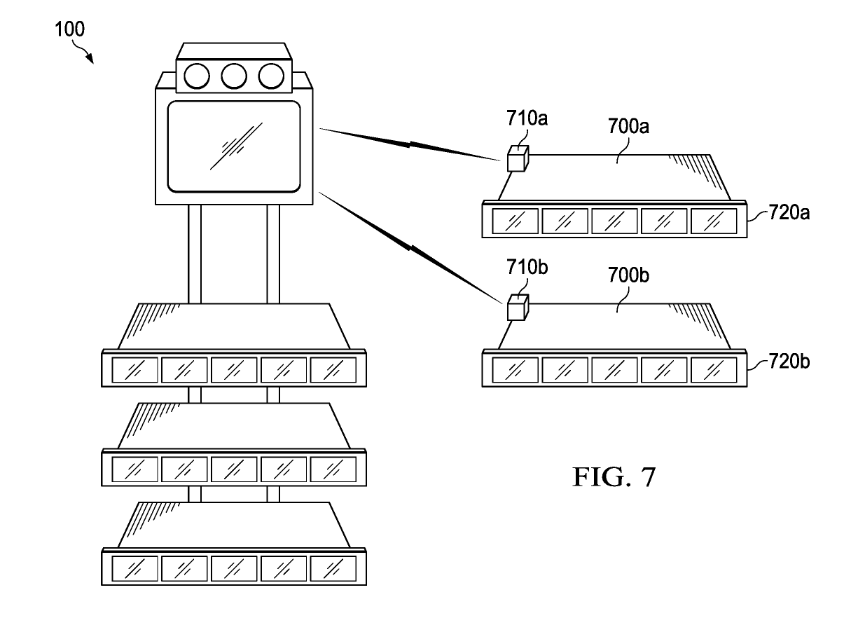

In addition to the one or more product shelves of the smart product display systems disclosed herein, the disclosed principles also encompass the use of one or more satellite display units. Such satellite display units are additional product display units, shelves or entire systems that in communication with a smart product display system such as the system 100 illustrated in FIG. 1. Looking at FIG. 7, illustrated is an exemplary embodiment of a plurality of satellite display units 700a, 700b that may be deployed in a store having the product display system 100, as well as be configured to communicate with the system 100. In the illustrated embodiment, the satellite display units are individual product display shelves 700a, 700b, which may be located together or geographically distinct from one another in the store having the product display system 100.

Such satellite display units 700a, 700b can be configured having any of the sensors, cameras, etc. described above with respect to the product shelves 110 of the system 100. Also, such satellite display units 700a, 700b include communication units 710a, 710b which are configured to communicate with one or more of the communications elements of the smart product display system 100. Such communication between the satellite display units 700a, 700b and the product display system 100 may be via wired or wireless means, and may be via any type of communications technology, such as Bluetooth or other NFC protocols, WiFi protocol, RF communication, cellular network, or any other type of wireless communication technology. Through such communication with the product display system 100, the satellite display units 700a, 700b, via their one or more sensors, can transmit product and consumer data equal to or exceeding the information discussed above with respect to display shelves 110. In addition, the satellite display units 700a, 700b can also receive communications from the product display system 100, such as any of the multimedia information discuss above. Moreover, the satellite display units 700a, 700b may also include display units 720a, 720b on any of the satellite display units 700a, 700b in order to present any of the multimedia content discussed above. Still further, the satellite display units 700a, 700b may include speakers or other components also capable of presenting multimedia content to consumers proximate to the satellite display units 700a, 700b. In this respect, the satellite display units 700a, 700b may include the same, less or even more functionality (and associated components) as the display shelves 110 discussed above, and thus operate in the same manner as those display shelves 110, but at a geographically different location as the smart product display system 100 while transmitting and receiving information to and from the system 100.

### Exemplary Event Types

Generally speaking, smart product display systems in accordance with the disclosed principles can be employed to provide a number of useful analytics related to consumer behaviors. As such, the product display systems may continuously sense and make records of its surroundings, including the shoppers near or at the unit and products being removed from shelves of the unit.

In embodiments where the product display system has shelves equipped with mini display units (such as the mini display unit 510 discussed above), the product display system may display appropriate messaging or other multimedia in those displays shelf-by-shelf. For example, the media might include pricing information, nutrition information, promotional information, product usage information, etc. Such disclosed product display systems may also be configured to continuously display certain types of multimedia in the unit's screens, such as video advertisements and still images that may be related to point of sales initiatives. When displaying video or still images, an accompanying sound track may also be played to supplement the messaging of the video or images. Additionally, the multimedia displayed could be continuously rolling, or it could be triggered based on detecting by the product display system of what product is selected by a shopper.

Triggering particular multimedia content could also be based on the product display system determining the mere presence of, or demographic information about, a shopper at the product display system. In such embodiments of a product display system, the system may be configured to display different advertisements if the system detects shoppers of a specific age, gender or other demographic detectable by the peripheries of the product display system. If multiple shoppers are simultaneously present at the product display system, the system could determine if a majority of shoppers have a specific demographic, and in response present multimedia directed more to that detected majority of the shoppers.

In product display systems of the disclosed principles having a 3D camera (and/or other mounted sensors), the capturing systems may be left active at all times and to perform a shopper Traffic Count event type as people walk in proximity to the product display system. Among the traffic metrics that may be captured are the traffic count for an event type occurring at the product display system, traffic count for shoppers passing the product display system or interacting with products on the product display system or the display system itself (e.g., the multimedia presented), dwell time for shoppers in proximity to the product display system, and various date & time/time periods/time frames for any of these or other metrics.

In addition to the traffic counts in various situations, and if multimedia content is being displayed by the product display system, then the camera and/or other sensors may capture incremental metrics related to shopper counts with an Impressions event type. Such metrics may be based on how many people are looking at the multimedia presented, the date/time the multimedia is being presented, what multimedia content was displayed, and for each shopper the dwell time during the multimedia presentation, age/gender and other detectable demographics, expression analysis (i.e., interest in content, unfocused attention, etc.) in product display systems having advanced camera capabilities, and product selection by detected shoppers. Of course, other metrics may also be captured in an Impression event type that could be advantageous to the retailer or the manufacturer, and those discussed herein are merely exemplary.

Product display systems may also be configured to record all stock removal by shoppers as a transaction. This may be done in various manners, such as by noting a mapping of the coordinates of the product that was removed against a preloaded planogram of current SKU products placed on a particular shelf. For such Stock Removal event types, transactions may record the positions of product being removed by shoppers, the SKU or other identifier of the product removed, the date/time of the transaction, remaining stock units of that SKU in the system, shopper demographics, and any other information that may be employed for tracking product stock removal by shoppers. Similarly, the product display system may also be configured to detect when shoppers put product back on the shelf different than the shelf from which it was removed. The system can record this transaction as a Stock Reposition event type, and can include capturing data such as the position of product being returned to a shelf, the predetermined SKU of product to be placed at that location, the date/time of the event, remaining stock units of that SKU calculated for that shelf, etc. Such an event allows the product display system to keep a more accurate metric of shopper behavior by determining whether products were actually purchased versus simply replaced to a different location or shelf.

More complex operations may also generate metrics based on events triggered from shopper behavior. One such example is a metric regarding adjacent product purchases. To generate such a metric, if a product is removed from a disclosed display system and within a preconfigured period of time another unit of stock is removed next to or otherwise proximate to or related to the first product (e.g., chips and salsa), and both products have different SKUs, then this event may be recorded as an event type of Adjacent Unit, and the SKU of both products is detected and the day/time of the event is recorded. The detection of the SKUs for each product may be in one of the exemplary manners discussed above, as well. This collection of information may then be used to determine a metric with regard to the popularity of different products being purchased together. Moreover, the metric may further include demographic information of the shoppers, as discussed above, or other information as well, as desired.

Another example of a more complex metric may be a combination of product selection and shopper impressions of the type discussed above. For example, if within a predetermined period of time (e.g., within 30 seconds) a product display system in accordance with the disclosed principles records a shopper's impressions, such as the watching of a specified amount of displayed multimedia content (e.g., a product advertisement), and the selection by that shopper of a product associated with the advertisement or other displayed content, an Ad Conversion event type is created. Detection of the shopper's impressions, as well as product removal from the product display system, may again be in the exemplary manners discussed above.

In a related example, the event type of Product Switching may be another complex metric derivable by the product display system. Such an event may be recorded when, within a predetermined period of time (e.g. within 30 seconds), Product A is detected being selected by a shopper, but this product is not being advertised by the product display system. Instead, media content for Product B is being presented by the product display system. Then, within that predetermined time period, the shopper is detected returning Product A to the product display system, and thereafter removes Product B from the display system, which can be attributed to the displayed media content. Additional impression detection of the shopper may also be included to more definitively relate the product switching with the presented media content. In these situations, product SKU may be detected again in the exemplary manner discussed above, as well as the detection of shoppers and perhaps their impressions as well.

Of course, other event types, simple or complex, may be programmed in the logic of a product display system according to the disclosed principles as may be useful for the retail location or the product supplier or manufacturer. Moreover, any event types may be programmed locally at the product display system, or remotely either proximate to the display system or via a telecommunications connection as discussed above. Also, programming may be accomplished by retail associates or associates related to product suppliers/manufacturers, or even simply by independent associates related only to the product display system itself and as instructed by one of the former. These events may also include feedback events in response to shoppers picking up a product from the shelf. This feedback could include product recommendations, serving suggestions, consumer reviews, and other brands' digital assets.

### Maintaining Data And Multimedia Assets

The maintenance of multimedia assets (i.e., content, etc.) and rules within a product display system in accordance with the disclosed principles may be accomplished in different ways. One such manner is where the product display system is fully online by being consistently connected to a telecommunication network (e.g., the internet) via sufficient bandwidth. This may be accomplished by the product display system maintaining an online connection via the retail location's WiFi or other local area network. The retail's internal network may then be connected externally. Another technique may be having the product display system connected via local area network to a dedicated network proprietary to the provider of the product display system, such as the Smart Equipment Network employed by PepsiCo®. Also, such consistent connectivity may be provided by the onboard equipment of the product display system connected via cellular technology, such a via a 4G or LTE telecommunications connection or any future cellular or other telecommunications technology. In each embodiment, accounting for the costs associated with consistent interconnectivity, such as a dedicated cellular data connection for each product display system may need to be accounted for, as well as any concerns for secure data transmissions across a retailer's WiFi network versus dedicated connection capabilities unique to the product display system. Regardless of the manner of maintaining a constant connection, in this mode the product display system is always connected with full bandwidth for upload of information and download of content. The display system may also be configured to check with a central system to determine scheduled downloads of new videos, images and sound files with attached attributes, such as, for example, dates for showing of the multimedia files and new rules for collecting and recording data and events.

An alternative manner of connection for a product display system of the disclosed principles is via limited connectivity. This manner of connection may be based on costs concerns, or perhaps for those situations where there is no local WiFi or other local area network connectivity available, and the availability of (or perhaps the costs associated therewith) of a full time cellular network data connection is not viable. In some such embodiments, the product display system may be configured to only use the cellular network data connection to transmit events that are needed on a real-time basis and on a schedule. Data compression may also be provided by the product display system to reduce the size of the data and thus reduce the cost of sending information. In other embodiments, local or cellular network connection may only be periodic, in which case the product display system may be configured to queue data for transmission, and transit and/or receive data during times of available connectivity.

In other embodiments, product display system may receive information, as well as provide captured/determined data, from associates local to the system. For example, associates related to the provider of the product display system may be scheduled to visit the retail locations where systems are deployed, and can directly download/upload data and rule elements to/from the product display systems. This could be done by wired or wireless connection as well. Such visiting may also be done in response to received notifications from the product display systems that indicates that there are data assets that need to be downloaded/uploaded. A custom application may be configured for use on associates' mobile devices to assist with what and when data and multimedia assets needed to be downloaded from or uploaded to the product display systems. Thus, when associates visit the location where the product display system is located, the mobile device may connect to the system's computer via either short range communications or any other means to establish two-way communications between the system and the associate's mobile device.

In the numerous embodiments of the inventive subject matter disclosed herein, such embodiments may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the claims reflect, inventive subject matter lies in less than all features of a single disclosed embodiment. Thus the following claims are hereby incorporated into the Detailed Description, with each claim standing on its own as a separate embodiment.

The description has made reference to several exemplary embodiments. It is understood, however, that the words that have been used are for description and illustration, rather than words of limitation. Changes may be made within the purview of the appended claims, as presently stated and as amended, without departing from the scope and spirit of the disclosure in all its aspects. Although this description makes reference to particular means, materials and embodiments, the disclosure is not intended to be limited to the particulars disclosed; rather, the disclosure extends to all functionally equivalent technologies, structures, methods and uses such as are within the scope of the appended claims.

What is claimed is:

1. A smart product display system for providing consumer purchasing behavior analytics, the system comprising:
a support structure having a power supply for powering one or more components of the smart product display system;
one or more display units for presenting multimedia to consumers;
one or more audio speakers for presenting multimedia to consumers;
one or more cameras for capturing information regarding consumers proximate to the product display system;
one or more shelves for providing products for selection by consumers, one or more of the shelves having on-shelf sensors for detecting product data regarding said provided products;
a data storage unit for storing the multimedia, captured information, and product data;
a processor for performing analytics regarding consumer shopping behavior with respect to products displayed on the product display system using one or more of the presented multimedia, the product data, and the captured information, the performed analytics storable in the data storage unit; and
a communications module for receiving and/or transmitting one or more of the presented multimedia, the product data, the captured information, and the performed analytics.

2. The product display system of claim 1, further comprising one or more mini display units on display edges of one or more of the shelves configured to display multimedia to consumers.

3. The product display system of claim 1, wherein at least one of the one or more cameras is a camera configured to capture demographic information of proximate consumers.

4. The product display system of claim 3, wherein the captured demographic information comprises one or more of age, gender and ethnicity of proximate consumers.

5. The product display system of claim 1, wherein the communications module comprises a near field communications unit.

6. The product display system of claim 5, wherein the near field communications unit is configured to interact with a mobile device of a consumer.

7. The product display system of claim 1, wherein the communications module comprises a telecommunications unit configured to communicate via WiFi, Ethernet, ZigBee, LAN, or cellular network.

8. The product display system of claim 1, wherein one or more of the on-shelf sensors are selected from pressure sensors, infrared sensors, sonar sensors, code scanning sensors, and image recognition sensors.

9. The product display system of claim 1, wherein the presented multimedia comprises one or more of advertisements, information, instructions, and promotional offers regarding one or more products displayed on the product display system.

10. The product display system of claim 1, wherein the presented multimedia is selected based at least on consumer demographic information determined by the product display system.

11. The product display system of claim 1, wherein the presented multimedia is selected based at least on a product displayed on the product display system being selected by a consumer.

12. The product display system of claim 11, wherein the selected multimedia comprises information regarding the selected product, other product recommendations based on the selected product, serving suggestions related to the selected product, and social media information related to the selected product.

13. The product display system of claim 1, wherein the communications module is configured to interact with a communications device of an associate of supplier of one or more products displayed on the one or more shelves.

14. The product display system of claim 1, wherein the performed analytics includes traffic counts of consumers, product stock removal by consumers, product stock repositioning by consumers, product stock switching by consumers, related product selections by consumers, multimedia impressions on consumers, and multimedia effect on consumer product stock selection.

15. The product display system of claim 1, further comprising one or more satellite display units located geographically distal from the product display system and for providing additional products for selection by consumers, the one or more satellite display units comprising one or more additional sensors for detecting additional product data regarding said additional provided products and configured to communicate said detected additional product data to said communications module.

16. A smart product display system for providing consumer purchasing behavior analytics, the system comprising:
a support structure having a power supply for powering one or more components of the smart product display system;
one or more display units for presenting multimedia to consumers;
one or more audio speakers for presenting multimedia to consumers;
one or more cameras for capturing demographic information regarding consumers proximate to the product display system;
a plurality of shelves for providing products for selection by consumers, one or more of the shelves having on-shelf sensors for detecting product data regarding said provided products;
a data storage unit for storing the multimedia, captured information, and product data;
a processor for performing analytics regarding consumer shopping behavior with respect to products displayed on the product display system using one or more of the presented multimedia, the product data, and the captured information, the performed analytics storable in the data storage unit; and
a communications module for receiving and/or transmitting one or more of the presented multimedia, the product data, the captured information, and the performed analytics;
wherein the communications module comprises a near field communications unit configured to interact with mobile devices and a telecommunications unit configured to communicate via a data network.

17. The product display system of claim 16, wherein the telecommunications unit is configured to communicate via WiFi, Ethernet, ZigBee, LAN, or cellular network.

18. The product display system of claim 16, wherein one or more of the on-shelf sensors are selected from pressure sensors, infrared sensors, sonar sensors, code scanning sensors, and image recognition sensors.

19. The product display system of claim 16, wherein the presented multimedia comprises one or more of advertisements, information, instructions, and promotional offers regarding one or more products displayed on the product display system.

20. The product display system of claim 16, wherein the presented multimedia is selected based at least on consumer demographic information determined by the product display system.

21. The product display system of claim 16, wherein the presented multimedia is selected based at least on a product displayed on the product display system being selected by a consumer.

22. The product display system of claim 16, wherein the performed analytics includes traffic counts of consumers, product stock removal by consumers, product stock repositioning by consumers, product stock switching by consumers, related product selections by consumers, multimedia impressions on consumers, and multimedia effect on consumer product stock selection.

23. The product display system of claim 16, further comprising one or more satellite display units located geographically distal from the product display system and for providing additional products for selection by consumers, the one or more satellite display units comprising one or more additional sensors for detecting additional product data regarding said additional provided products and configured to communicate said detected additional product data to said communications module.
